(19) United States
(12) Patent Application Publication
(10) Pub. No.: US 2003/0203346 A1
(43) Pub. Date: Oct. 30, 2003

(54) Method for interactive testing

(76) Inventors: Say-Yee Wen, Taipei (TW); Shih-Li Wen, Taipei (TW)

Correspondence Address: BIRCH STEWART KOLASCH & BIRCH, PO BOX 747, FALLS CHURCH, VA, 22040-0747, US

(21) Appl. No.: 10/131,098

(22) Filed: Apr. 25, 2002

(51) Int. Cl. G09B 7/00

(52) U.S. Cl. 434/322

(57) ABSTRACT

A method for interactive testing that enables a test to be conducted on-line after a lesson by means of a plurality of data processing platforms. With this method, a test is characterized by the classification of hint levels, and a hint is useful to a candidate in giving a correct answer. After the test, the candidate's score on the test depends on the extent to which the hints help the candidate come up with correct answers. The method allows the results and efficiency of learning to be evaluated in a fair and fast manner.

### FIELD OF THE INVENTION

The invention relates to an interactive test method, and more particularly, to a hint-based interactive test method.

### BACKGROUND OF THE INVENTION

In education nowadays, not only do teachers propagate doctrines of ancient sages, teach working skills and enlighten their students, but they also have to understand the progress rate of their students. As for the latter, a test is the easiest means for understanding the results and efficiency of the students' learning. In a traditional test, a student is required to put all the answers on a test paper. The student's score on the test is not worked out unless and until the test paper is marked. This means a great waste of educational resources with respect to materials or in terms of the time and manpower required for marking test papers. For this reason, test papers are also marked with a computer.

A computer marks test papers when cards bearing answers are read by the computer's optical recognition system. Then students' scores on the test can be worked out. Although computers help teachers mark test papers, record students' scores and rank students according to their grades, a considerable number of cards have to be used. Even worse, test papers marked by computers can only consist of multiple choice questions. It is doubtful whether such tests are fair.

The questions on traditional tests are also characterized by their inflexible “one question, one answer” format, making students learn everything by rote. As a result, teaching becomes inefficient and students are incapable of associative thinking. In addition, while doing a test, students are so nervous that sometimes they fail to recall what they have learned. Thus the test does not evaluate the result and efficiency of their learning objectively and effectively.

Therefore, there is still room for improvement in such areas as tests with classification of hints levels, hints that can be searched for and retrieved in real time by test candidates with wireless transmission functions of data processing platforms, and the way candidates' scores are worked out speedily and accurately according to the extent to which the hints help the candidates come up with correct answers.

### OBJECT AND SUMMARY OF THE INVENTION

In view of the aforesaid problems of the known technology, the object of the invention is to provide an interactive test method, that is, a method for conducting an online test by wireless transmission. The method enables candidates to work on a test with a classification of hint levels to search for and retrieve in real time by means of the wireless transmission function of data processing platforms.

The on-line test put forth by the invention is conducted through a Local Area Network (LAN) formed by the data processing platform of an examiner end and the data processing platforms of a plurality of candidate ends. The method comprises the following steps: start the data processing platform of an examiner end and the data processing platforms of a plurality of candidate ends, and link the data processing platform of the examiner end with the data processing platforms of a plurality of candidate ends in a “one-to-many” pattern; the data processing platform of the examiner end sends a test to the data processing platforms of a plurality of candidate ends; the data processing platform of the examiner end starts a time count for the test; ask the candidates whether they need any hints for the test or not; individual data processing platforms of a plurality of candidate ends generate a hint level in accordance with the type of hints used by individual candidates to answer the questions of the test; when the time is up, stop the data processing platforms of the plurality of candidate ends; and, save the answers and the hint level data of the individual data processing platforms of the plurality of candidate ends in the data processing platform of the examiner end.

Another object of the invention is to provide a method for marking test papers in an off-line state, that is, a method for calculating the candidates scores with the data processing platform of the examiner end functioning in an off-line state. The method comprises the following steps: start the data processing platform of the examiner end and retrieve an answer of a candidate and a hint level; receive the candidate's answer, compare the candidate's answer with the model answer saved in the data processing platform of the examiner end, and generate a gross score; evaluate the hint level and generate a deduction score; and, work out individual candidates' scores and save the scores in the data processing platform of the examiner end.

The data processing platform mentioned above can be a Personal Digital Assistant (PDA), a portable computer, or a mobile communication device.

As regards the characteristics and implementation of the invention, illustration and detailed explanations of a preferred embodiment are given below.

### DETAILED DESCRIPTION OF THE PREFERRED EMBODIMENT

The invention allows a test for interactive teaching to be conducted through a wireless LAN formed by a plurality of data processing platforms in a “one-to-many” pattern. A preferred embodiment is depicted below to give a concrete explanation as to the feasibility of the invention. First of all, please refer to FIG. 1. The data processing platform of the examiner end 10 comprises a central processing unit 11, a start input unit 12, an output display unit 13, a data storage unit 14 and a wireless transmission unit 15. A data processing platform of the candidate end 20 also comprises a central processing unit 21, a start input unit 22, an output display unit 23, a data storage unit 24 and a wireless transmission unit 25.

Firstly, start the data processing platform of the examiner end 10 with the start input unit 12, enter a test question and a corresponding hint, and check them in the output display unit 13. Save all the input data in the data storage unit 14. At this point, the data processing platform of the examiner end 10 is ready to transmit data in an on-line manner with the wireless transmission unit 15. The start input unit 22 starts the data processing platforms of a plurality of candidate ends 20. Data are received by individual data processing platforms through the wireless transmission unit 25 and then saved in the data storage unit 24. As a result, a candidate can take a test in a data processing platform of the candidate end 20 with the start input unit 22 and the output display unit 23. The test paper contains a classification of hints levels, so that candidates taking the test can search for and retrieve hints in real time by means of the wireless transmission function of data processing platforms. The answers given by the candidates are saved in the data storage unit 24. With the two-way transmission conducted by and between the two wireless transmission units 15 & 25 located at both ends, the answers are eventually saved in the data storage unit 14 of the data processing platform of the examiner end 10. Examiners may use the data processing platform of the examiner end 10 to work out the candidates' scores, finishing the whole process of the test for interact teaching.

For the process of actual operation of the on-line test put forth by the invention, please refer to FIG. 2. Before conducting a test for interactive teaching, the first thing to do is to construct a wireless LAN by linking the data processing platform of the examiner end 10 with the data processing platforms of a plurality of candidate ends 20 in a “one-to-many” pattern. Once the test begins, the candidates have to confirm their identities at the candidate ends (step 100). After successful confirmation of identity, a candidate end receives test questions sent by the examiner end (step 110).

An examiner may set the test duration at the examiner end and start a time count (step 120). At this point, candidates may begin to work on the test at the candidate ends (step 130). In the course of the test, a pop-up window appears at the candidate ends, asking the candidates whether a hint is wanted or not whenever they are unable to answer a test question (step 140). If a candidate wants a hint, the candidate end will be linked with the examiner end so as to download the hint (step 150). Since the test paper has a classification of hint levels, the candidate end generates a hint level in accordance with the type of hint (step 160). The hint helps the candidate continue working on the test paper at the candidate end (step 170) or do his or her revision.

When the time is up, the candidate ends are stopped from inputting data (step 180). Nevertheless, candidates are allowed to hand in their test papers before the end of the test, provided that they set a stop answering command at the candidate end. At this point, the answers and the hint level data found at the candidate ends are immediately saved in the examination end by means of the wireless transmission carried out at both ends (step 190). The answers and the hint level data are saved along with the candidates' identification data. As a result, it is possible to understand the result and efficiency of an individual's learning. At this point, we have completed the test for interactive teaching.

Please refer to FIG. 3 for the process of marking test papers in an off-line state. Teachers who mark the test papers may retrieve the candidates' answers and hint level data from the examiner end (step 210), and compare the candidates' answers with the model answers (step 220). In the course of marking test papers, the examiner end automatically determines whether the candidates' answers are correct or not (step 230). If the candidates' answers are wrong, the teachers who mark the test papers may score the candidates' answers at their discretion (step 240). If the candidates' answers are correct, the examiner end assesses the scores attributed to the hints and the extent to which the hints were used by the candidates in the test (step 250), and works out the scores the candidates deserve (step 260). Lastly, the final grades are saved in the examiner end (step 270). The answers and the hint level data are saved along with the candidates' identification data. As a result, it is possible to rank.

The data processing platform mentioned above can be a Personal Digital Assistant (PDA), a portable computer, or a mobile communication device.

### EFFECTS OF THE INVENTION

The invention puts forth an interactive test method, with an eye to solving the problems of traditional tests. Traditional tests fail to evaluate the results and efficiency of the candidates learning in an objective manner, as the test questions appear in an inflexible “one question, one answer” format. In addition, a lot of manpower and time are spent on marking test papers. The invention has the following effects:

1. The invention allows an interactive test to be conducted by means of data processing platforms and their wireless transmission function. It saves materials, such as paper, and the manpower and time spent on marking test papers.

2. It enables candidates to work on a test with a classification of hint levels to search for and retrieve hints in real time by means of the wireless transmission function of data processing platforms.

While the invention has been described by way of example and in terms of a preferred embodiment, it is to be understood that the invention is not limited thereto. It should be understood that the detailed description and specific examples, while indicating preferred embodiments of the invention, are given by way of illustration only, since various changes and modifications within the spirit and scope of the invention will become apparent to those skilled in the art from this detailed description. Therefore the scope of protection for the invention should conform to the claims attached below.

### BRIEF DESCRIPTION OF THE DRAWINGS

FIG. 1 is an overall block diagram of the invention;

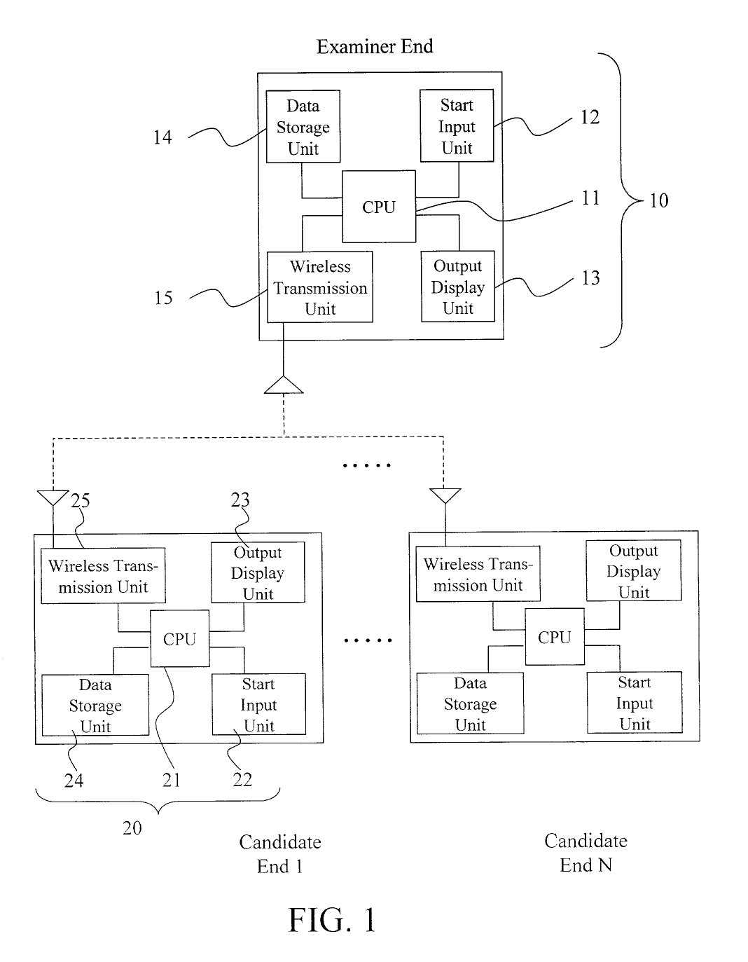

FIG. 2 is a flowchart of the overall operation of the on-line test put forth by the invention; and

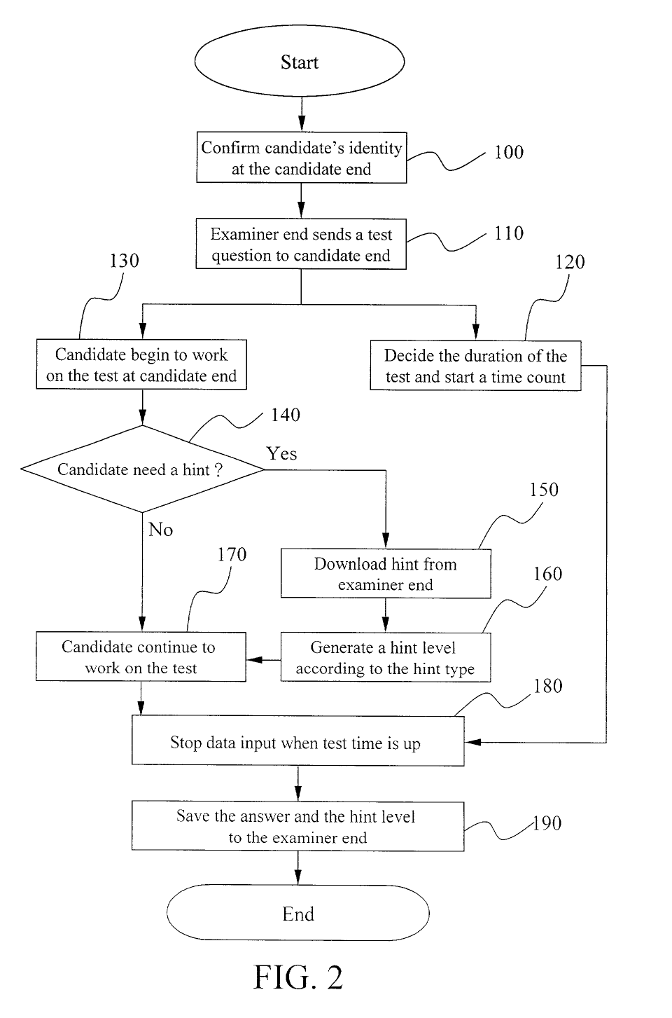

FIG. 3 is a flowchart of the overall operation of marking the tests off-line in the invention.

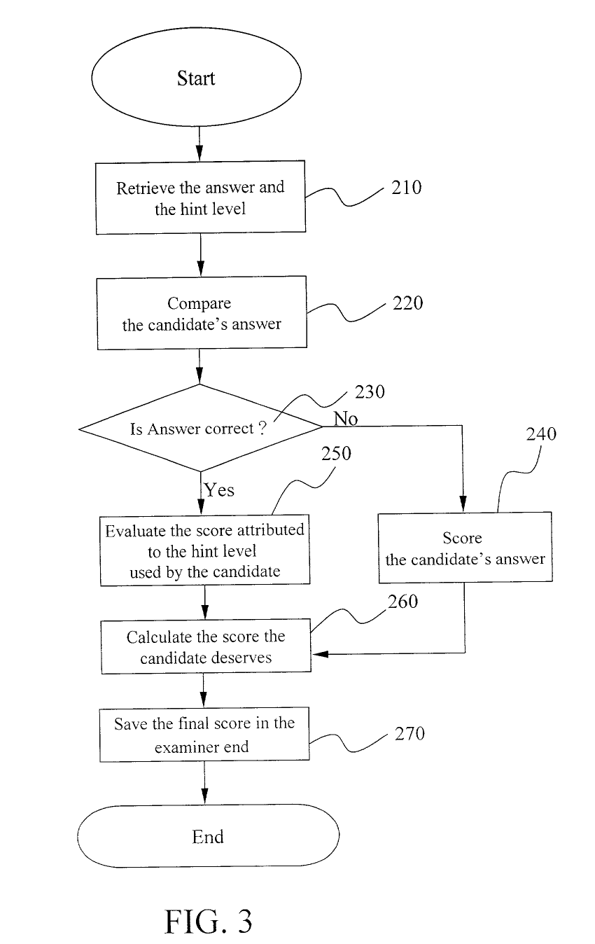

What is claimed is:

1. A method for interactive testing, conducted by wireless transmission, through a Local Area Network formed by the data processing platform of an examiner end and the data processing platforms of a plurality of candidate ends, which comprising the steps of:
starting the data processing platform of the said examiner end and the data processing platforms of a plurality of said candidate ends, and link the data processing platform of the said examiner end with the data processing platforms of a plurality of said candidate ends in a “one-to-many” pattern;
sending a test question from the data processing platform of the said examiner ends to the data processing platforms of a plurality of said candidate ends;
starting a time count for the test by the data processing platform of the said examiner end;
sending a hint to the data processing platforms of a plurality of said candidate ends, and generates hint level according to the type of the said hint by the data processing platform of the said examiner end;
stopping the data processing platforms of a plurality of said candidate ends from inputting any answer when time is up; and
saving the said answer and the said hint level of the data processing platforms of a plurality of said candidate ends in the data processing platform of the said examiner end.

2. The method for interactive testing of claim 1, wherein the said data processing platform can be selected from the group consisting of a Personal Digital Assistant, a portable computer, and a mobile communication device.

3. The method for interactive testing of claim 1, wherein after linking the data processing platform of the said examiner end and the data processing platforms of a plurality of said candidate ends, further comprising the step in which candidates' identities are confirmed in the data processing platforms of a plurality of said candidate ends.

4. The method for interactive testing of claim 1, further comprising the step in which candidates may take the liberty of setting a stop answering command in the data processing platforms of the said candidate ends before the end of the said test.

5. The method for interactive testing of claim 1, wherein the said answer and the said hint level are found in individual data processing platforms of a plurality of said candidate ends along with an identification data of the candidate, and saved in the data processing platform of the said examiner end.

6. A method for interactive testing, using the data processing platform of an examiner end to check candidates' grades in an off-line state, which comprising the steps of:
starting the data processing platform of the said examiner end, and retrieve an answer of a candidate and a hint level;
receiving the said answer, compare it with the model answer saved in the data processing platform of the said examiner end, and generate a gross score;
evaluating the said hint level, and generate a deduction score; and
working out each candidate's score in the test, and save the said score in the data processing platform of the said examiner end.

7. The method for interactive testing of claim 6, wherein the said data processing platform can be selected from the group of a Personal Digital Assistant, a portable computer, and a mobile communication device.

8. The method for interactive testing of claim 6, further comprising the step in which the said answer is scored according to its contents at one's discretion.

9. The method for interactive testing of claim 6, wherein the said grade for the test is found along with an identification data of the candidate, and are saved in the data processing platform of the said examiner end.

10. A method for interactive testing retrieving a hint by linking the data processing platforms of a plurality of candidate ends to the data processing platform of an examiner end in an on-line state, which comprising the steps of:
viewing candidates' states of answering in the data processing platforms of a plurality of said candidate ends by the data processing platform of the said examiner end;
sending an answer request message to the data processing platforms of a plurality of said candidate ends by the data processing platform of the said examiner end;
receiving the said answer request message by the data processing platforms of a plurality of said candidate ends, and the candidates may decide whether or not they need a hint and they may generate an answer message;
receiving the said answer message, and sends the hints wanted by individual data processing platforms of a plurality of said candidate ends by the data processing platform of the said examiner end; and
generating a hint level datum according to the types of the said hint by the data processing platforms of a plurality of said candidate ends.

11. The method for interactive testing of claim 10, wherein the said data processing platform can be selected from the group consisting of a Personal Digital Assistant, a portable computer, and a mobile communication device.
